(19) United States
(12) Patent Application Publication
(10) Pub. No.: US 2026/0224982 A1
(43) Pub. Date: Aug. 6, 2026

(54) ONE OR MORE NON-TRANSITORY COMPUTER-READABLE STORAGE MEDIA, COMPUTER-IMPLEMENTED METHOD, AND INFORMATION PROCESSING SYSTEM

(71) Applicant: Nintendo Co., Ltd., Kyoto (JP)

(72) Inventors: Masato ORISHIGE, Kyoto (JP); Yoshinori KONISHI, Kyoto (JP)

(21) Appl. No.: 19/408,032

(22) Filed: Dec. 3, 2025

(30) Foreign Application Priority Data
Jan. 31, 2025 (JP) 2025-014927

(51) Int. Cl. A63F 13/428; A63F 13/533; G06F 3/0346; G06F 3/0354; G06F 3/04812

(52) U.S. Cl. CPC A63F 13/428; A63F 13/533; G06F 3/0346; G06F 3/03543; G06F 3/04812

(57) ABSTRACT

First input device data including inertial sensor data and mouse sensor data of a first input device is acquired, second input device data including inertial sensor data and mouse sensor data of a second input device is acquired, processing corresponding to a set operation mode is performed based on these acquired data, a first operation mode is set if an orientation of the first input device satisfies a first condition, the first operation mode is set if an orientation of the second input device satisfies a second condition, a second operation mode is set if the orientation of the first input device satisfies a third condition and the orientation of the second input device satisfies a fourth condition, and processing corresponding to the first operation mode includes processing in which an object is operated based on at least one of the first or second mouse data.

### CROSS REFERENCE TO RELATED APPLICATION

This application claims priority to Japanese Patent Application No. 2025-14927 filed on January 31, 2025, the entire contents of which are incorporated herein by reference.

### FIELD

The present disclosure relates to processing of data based on an operation on an input device.

### BACKGROUND AND SUMMARY

Conventionally, input devices such as game controllers have been known.

There is room to provide an appropriate operation mode corresponding to an operation manner when a controller is operated by each hand in various manners.

For example, the following configuration examples are exemplified.

A first configuration example is directed to one or more non-transitory computer-readable storage media having stored therein instructions that, when executed, cause one or more processors to perform operations including: acquiring first input device data including first inertial data corresponding to an output of an inertial sensor of a first input device and first mouse data corresponding to an output of a mouse sensor of the first input device; acquiring second input device data including second inertial data corresponding to an output of an inertial sensor of a second input device and second mouse data corresponding to an output of a mouse sensor of the second input device; performing processing corresponding to a set operation mode, based on the first input device data and the second input device data; setting a first operation mode, based on an orientation of the first input device satisfying a first condition; setting the first operation mode, based on an orientation of the second input device satisfying a second condition; and setting a second operation mode, based on the orientation of the first input device satisfying a third condition and the orientation of the second input device satisfying a fourth condition, wherein processing corresponding to the first operation mode includes processing in which an object is operated based on at least one of the first mouse data or the second mouse data.

In a second configuration example based on the first configuration example, the first condition may be a condition satisfied when a mouse sensor opening of the first input device faces at least in a gravity direction, and the second condition may be a condition satisfied when a mouse sensor opening of the second input device faces at least in the gravity direction.

In a third configuration example based on the first or second configuration example, the third condition may be a condition satisfied when the mouse sensor opening of the first input device faces at least in a direction perpendicular to the gravity direction, and the fourth condition may be a condition satisfied when the mouse sensor opening of the second input device faces at least in the direction perpendicular to the gravity direction.

In a fourth configuration example based on any one of the first to third configuration examples, the operations may further include: setting the first operation mode, based on the orientation of the first input device satisfying the first condition and satisfying a condition satisfied when the mouse sensor opening of the first input device is closed; and setting the first operation mode, based on the orientation of the second input device satisfying the second condition and satisfying a condition satisfied when the mouse sensor opening of the second input device is closed.

In a fifth configuration example based on any one of the first to fourth configuration examples, the operations may further include, regardless of whether or not the condition satisfied when the mouse sensor opening of the first input device is closed and the condition satisfied when the mouse sensor opening of the second input device is closed are satisfied, setting the second operation mode, based on the orientation of the first input device satisfying the third condition and the orientation of the second input device satisfying the fourth condition.

In a sixth configuration example based on any one of the first to fifth configuration examples, processing corresponding to the second operation mode may be processing in which the object is not operated based on the first mouse data and the second mouse data.

In a seventh configuration example based on the sixth configuration example, processing corresponding to the second operation mode may be processing in which no object is operated based on the first mouse data and the second mouse data.

In an eighth configuration example based on any one of the first to seventh configuration examples, the object may be a cursor. The first input device data may include first operation portion data corresponding to a user operation on an operation portion of the first input device, and processing corresponding to the second operation mode may include processing in which the cursor is moved based on the first operation portion data.

In a ninth configuration example based on the eighth configuration example, the processing corresponding to the first operation mode may include processing in which the cursor is continuously moved based on at least one of the first mouse data or the second mouse data, and the processing corresponding to the second operation mode may include processing in which the cursor is discontinuously moved based on the first operation portion data.

In a tenth configuration example based on the ninth configuration example, the cursor displayed when the first operation mode is set and the cursor displayed when the second operation mode is set may be the same.

In an eleventh configuration example based on the tenth configuration example, while the first input device and the second input device are not being operated, the cursor displayed when the first operation mode is set may be stopped, and the cursor displayed when the second operation mode is set may be moved.

In a twelfth configuration example based on any one of the first to eleventh configuration examples, the processing corresponding to the first operation mode may include processing in which the object is operated based on both the first mouse data and the second mouse data.

In a thirteenth configuration example based on any one of the first to twelfth configuration examples, the operations may further include performing game processing, and the game processing may include a game portion in which both the first mouse data and the second mouse data are used, and a menu portion in which one of a plurality of operation modes including the first operation mode and the second operation mode is set.

Each configuration example described above may be applied to a computer-implemented method or an information processing system.

### BRIEF DESCRIPTION OF THE DRAWINGS

FIG. 1 is a diagram showing a non-limiting example of a state where a right controller 3 and a left controller 4 are attached to a main body apparatus 2;

FIG. 2 is six orthogonal views showing a non-limiting example of the right controller 3;

FIG. 3 is six orthogonal views showing a non-limiting example of the left controller 4;

FIG. 4 is a block diagram showing a non-limiting example of the configuration of the main body apparatus 2;

FIG. 5 is a block diagram showing a non-limiting example of the configurations of the main body apparatus 2, the right controller 3, and the left controller 4;

FIG. 6 is a diagram showing a non-limiting example of a state where the controllers are operated while being grasped by both hands;

FIG. 7 is a diagram showing a non-limiting example of a state where the controllers are operated as mice by both hands;

FIG. 8 is a diagram showing a non-limiting example of a state where the right controller 3 is operated as a mouse by a right hand and the left controller 4 is operated while being grasped by a left hand;

FIG. 9 is a diagram showing a non-limiting example of a state where the right controller 3 is operated while being grasped by both hands in a horizontal holding manner.

FIG. 10 illustrates a non-limiting example of a first operation method;

FIG. 11 illustrates a non-limiting example of a second operation method;

FIG. 12 shows a non-limiting example of various data; and

FIG. 13 shows a non-limiting example of a sequence.

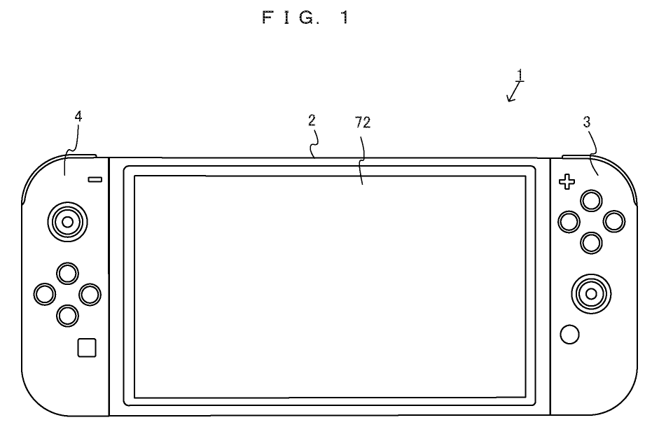

### DETAILED DESCRIPTION OF NON-LIMITING EXAMPLE EMBODIMENTS

Hereinafter, an exemplary embodiment will be described.

### Example of hardware configuration of information processing system

Hereinafter, a game system which is an example of an information processing system will be described. A game system 1 according to the exemplary embodiment includes a main body apparatus 2, a left controller 4, and a right controller 3. The main body apparatus 2 is an example of an information processing apparatus. The information processing apparatus may be, for example, a personal computer, a tablet terminal, a smartphone, a wearable terminal, a server, or the like. The left and right controllers 3 and 4 are examples of an input device. The input device does not have to be attachable to and detachable from the main body apparatus 2. The input device is also an example of the information processing apparatus. The information processing apparatus and the input device are examples of a computer. The term “computer” does not necessarily mean one device and can mean the entirety of a plurality of devices connected via a wire or wirelessly. Each of such information processing apparatuses and input devices can be an example of the information processing system.

The main body apparatus 2 is an apparatus for executing various kinds of processing (e.g., game processing) in the game system 1. In the exemplary embodiment, the main body apparatus 2 includes a display 72.

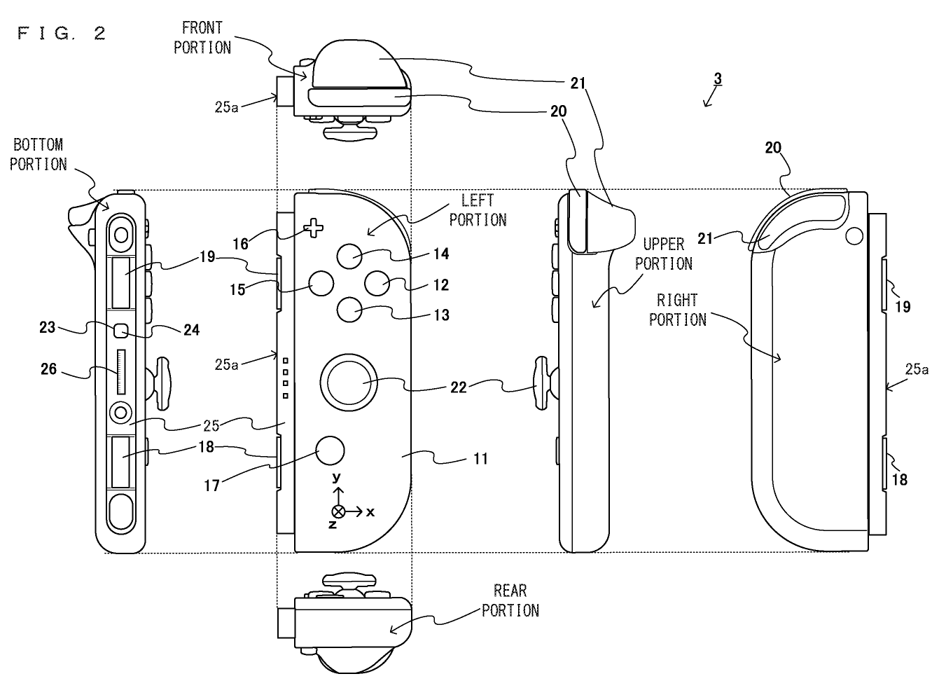

The left controller 4 and the right controller 3 are each an input device including operation portions and the like on which a user performs input. Hereinafter, the left controller 4 and the right controller 3 are sometimes collectively referred to as “controller”. FIG. 2 is six orthogonal views schematically showing an example of the right controller 3. As shown in FIG. 2, the right controller 3 has a vertically long plate shape, has a housing 11, and has a front portion, a rear portion, an upper portion, a bottom portion, a right portion, and a left portion. As described later, an opening for a mouse sensor (hereinafter sometimes referred to as mouse sensor opening) is provided in the bottom portion. In the right controller 3, the rear portion is located on a side opposite to the front portion, the bottom portion is located on a side opposite to the upper portion, and the left portion is located on a side opposite to the right portion. The distance between the front portion and the rear portion is larger than the distance between the upper portion and the bottom portion. The distance between the upper portion and the bottom portion is larger than the distance between the right portion and the left portion. In another exemplary embodiment, these distances may have another magnitude relationship. In the exemplary embodiment, a direction connecting the bottom portion and the upper portion is referred to as an up-down direction, a direction perpendicular to the up-down direction and connecting the front portion and the rear portion is referred to as a front-rear direction, and a direction perpendicular to the up-down direction and connecting the right portion and the left portion is referred to as a left-right direction. In FIG. 2, x, y, and z axes are shown on a front view in which the left portion faces the near side, and represent a coordinate system of the right controller 3. In this coordinate system, a direction heading toward the right portion from the left portion is a z-axis plus direction. A direction perpendicular to the z axis and heading toward the upper portion from the bottom portion is an x-axis plus direction. A direction perpendicular to the z axis and the x axis and heading toward the front portion from the rear portion is a y-axis plus direction. When the bottom portion is directed in the gravity direction, an x-axis minus direction and the gravity direction coincide with each other. In the exemplary embodiment, portions such as the front portion and the bottom portion need not be perfectly flat, and may have a recess, a projection, and/or a slope. For example, the bottom portion includes a protruding portion 25 described later. A direction in which each portion faces and a direction connecting the portions are shown as approximate directions.

The right controller 3 has the protruding portion 25 which is fitted into a recessed portion (not shown) of the main body apparatus 2 in a state where the right controller 3 is attached to the main body apparatus 2. As shown in FIG. 2, the protruding portion 25 has a protruding shape protruding in the x-axis minus direction and having a left-right width shorter than that of the right controller 3 and a front-rear width shorter than that of the right controller 3. In the exemplary embodiment, the protruding portion 25 is a part of the bottom portion.

As described later, the right controller 3 can be grasped in an orientation in which the right controller 3 is vertically long, in a state of being detached from the main body apparatus 2. The right controller 3 has such a shape and a size that the right controller 3 can be grasped by one hand, in particular, a right hand, in a case of being grasped in the orientation in which the right controller 3 is vertically long. The right controller 3 can also be grasped in an orientation in which the right controller 3 is horizontally long, and may be grasped by both hands in a case of being grasped in the orientation in which the right controller 3 is horizontally long.

The right controller 3 has, at the left portion, an analog stick (sometimes simply referred to as a “stick”) 22 which is an example of a directional input portion. The stick 22 can be used as a directional input portion via which a direction can be inputted. The user can perform directional input corresponding to a tilt direction by tilting the stick 22 in a desired direction in a range of 360 degrees, and can perform input with a magnitude corresponding to the tilt angle. In addition, the user can perform button input by pushing the stick 22 in. The stick may be slidable, instead of being tiltable. The directional input portion may, for example, be a directional pad or a slide pad.

The right controller 3 has, at the left portion, a set of four buttons which are an A button 12, a B button 13, an X button 14, and a Y button 15, a + (plus) button 16, and a home button 17. The right controller 3 has an R button 20 and a ZR button 21 over a range from the front portion to the upper portion. The R button 20 and the ZR button 21 may be provided at only the front portion of the right controller 3, or may be provided only at the upper portion of the right controller 3. The right controller 3 has a button 18 and a button 19 at a top surface 25a of the protruding portion 25. The right controller 3 has no operation portion at the rear portion.

The right controller 3 has an opening 23 for a mouse sensor, at the top surface 25a of the protruding portion 25. The opening 23 for a mouse sensor is an opening of a light guide path for guiding light to a mouse sensor 24 provided inside the right controller 3. The mouse sensor 24 is an optical mouse sensor and includes at least a light receiving portion. Light to be detected by the light receiving portion may be visible light or light having an invisible wavelength. The mouse sensor 24 may include a light emitting portion. Light from the light emitting portion may be emitted through the opening 23 to the outside. The mouse sensor 24 acquires data that enables calculation of movement or the like, on a placement surface, of the right controller 3 placed such that the top surface 25a of the protruding portion 25 of the bottom portion faces the placement surface. Thus, the right controller 3 can be used also as a mouse. In the exemplary embodiment, the direction in which the bottom portion extends when the right controller 3 is placed on the placement surface with the top surface 25a facing the placement surface is parallel to the direction in which the placement surface extends.

In the exemplary embodiment, the right controller 3 has, at the protruding portion 25, a terminal 26 for the right controller 3 to perform wired communication with the main body apparatus 2. The terminal 26 is provided on the inner peripheral surface of a recess formed in the top surface 25a of the protruding portion 25, for example.

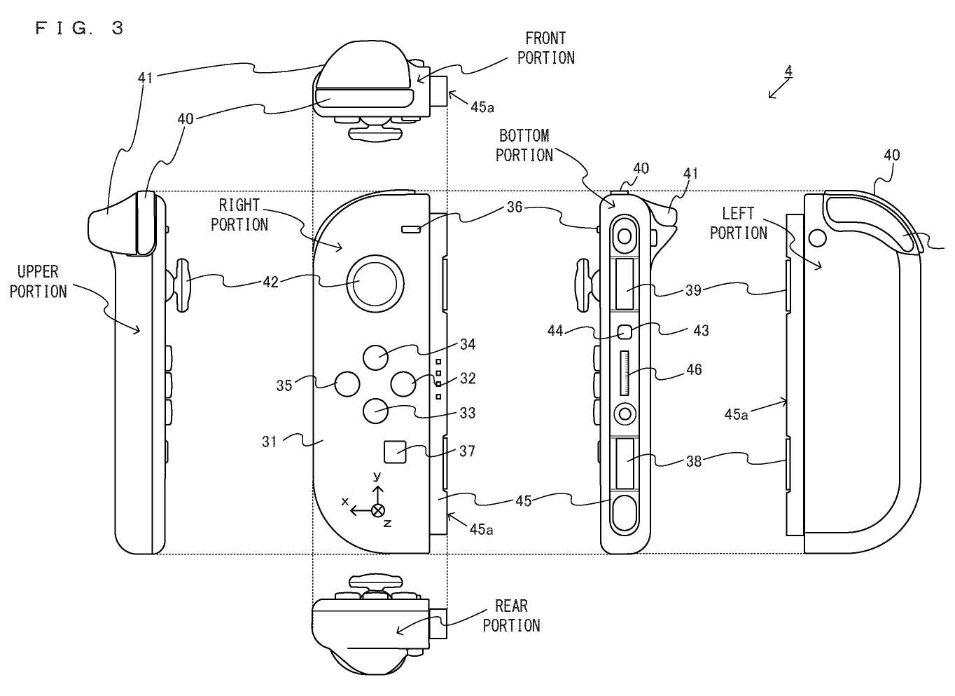

FIG. 3 is six orthogonal views schematically showing an example of the left controller 4. The description of similar configurations as those of the right controller 3 is omitted. The left controller 4 has, at a right portion, a stick 42, a set of four buttons which are a right direction button 32, an up direction button 33, a down direction button 34, and a left direction button 35, a capture button 37, and a − (minus) button 36. The buttons 32 to 35 may be one directional pad. The left controller 4 has no operation portion at the rear portion. In the right controller 3, the stick 22 is located rearward of the buttons 12 to 15, whereas in the left controller 4, the stick 42 is located frontward of the buttons 32 to 35. In FIG. 3, x, y, and z axes are shown on a front view in which the right portion faces the near side, and represent a coordinate system of the left controller 4. In this coordinate system, a direction heading toward the left portion from the right portion is a z-axis plus direction. A direction perpendicular to the z axis and heading toward the upper portion from the bottom portion is an x-axis plus direction. A direction perpendicular to the z axis and the x axis and heading toward the front portion from the rear portion is a y-axis plus direction. When the bottom portion is directed in the gravity direction, an x-axis minus direction and the gravity direction coincide with each other.

The left controller 4 has a protruding portion 45 which is fitted into a recessed portion (not shown) of the main body apparatus 2 in a state where the left controller 4 is attached to the main body apparatus 2. As with the right controller 3, the protruding portion 45 includes buttons 38 and 39, a mouse sensor 44, and a terminal 46.

As with the right controller 3, the left controller 4 can be grasped in an orientation in which the left controller 4 is vertically long or horizontally long, in a state of being detached from the main body apparatus 2.

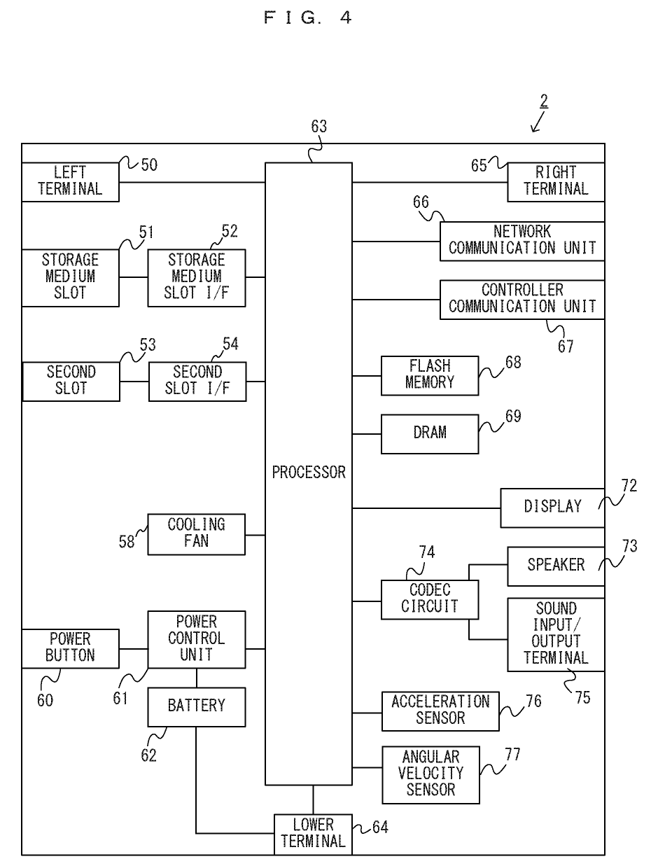

FIG. 4 is a block diagram showing an example of the internal configuration of the main body apparatus 2. The main body apparatus 2 includes a processor 63. The processor 63 is an information processing unit which executes various kinds of information processing to be executed in the main body apparatus 2. The processor 63 may be composed of, for example, a plurality of processors and cores, or typically, a plurality of CPUs (Central Processing Units) and cores, or may be formed by a SoC (System-on-a-chip) including a plurality of functions such as a CPU function and a GPU (Graphics Processing Unit) function. In the exemplary embodiment, the term “processor” may include at least a CPU (Central Processing Unit), a GPU (Graphics Processing Unit), an ASIC (Application Specific Integrated Circuit), an FPGA (Field Programmable Gate Array), etc. The processor 63 executes various kinds of information processing by executing a program (e.g., a program for executing a game application, etc.) stored in a storage unit (e.g., an internal storage medium such as a flash memory 68, an external storage medium attached to a slot 51 or the like, etc.).

The main body apparatus 2 includes the flash memory 68, and a DRAM (Dynamic Random Access Memory) 69, as an example of an internal storage medium. The flash memory 68 is a memory that is mainly used for storing various data to be stored in the main body apparatus 2. The DRAM 69 is a memory that is mainly used for temporarily storing various data to be used in information processing. The processor 63 reads and writes data from and into storage media such as the flash memory 68 and the DRAM 69 as appropriate, to execute various kinds of information processing. In the exemplary embodiment, the term “memory” may include at least a flash memory and a DRAM, and may include another storage medium.

The main body apparatus 2 includes various components as shown in FIG. 4. Hereinafter, the components will be briefly described. A storage medium slot interface (sometimes referred to as “slot I/F”) 52 performs reading/writing of data from/into a storage medium (e.g., a dedicated memory card) attached to the storage medium slot 51, in response to an instruction from the processor 63. A second slot I/F 54 performs reading/writing of data from/into a storage medium attached to a second slot 53, in response to an instruction from the processor 63.

A network communication unit 66 performs communication (e.g., Internet communication using wireless communication) with an external device via a network. A controller communication unit 67 performs wireless communication (e.g., communication compliant with the standard of Bluetooth (registered trademark)) with the left controller 4 and/or the right controller 3.

A left terminal 50 is a terminal for performing wired communication between the processor 63 and the left controller 4. A right terminal 65 is a terminal for performing wired communication between the processor 63 and the right controller 3. A lower terminal 64 is a terminal for performing communication with another apparatus (e.g., a stationary monitor) via a cradle when the lower terminal 64 is attached to the cradle, for example.

A codec circuit 74 controls input and output of sound data to and from a speaker 73 and a sound input/output terminal 75.

A power control unit 61 controls supply of power from a battery 62 to each unit of the main body apparatus 2 (i.e., each of units to be supplied with power from the battery 62), based on an instruction from the processor 63, and starts or stops supply of power in response to pressing of a power button 60.

The main body apparatus 2 includes various sensors such as an acceleration sensor 76 and an angular velocity sensor 77. The processor 63 can execute various kinds of processing, based on information from these sensors.

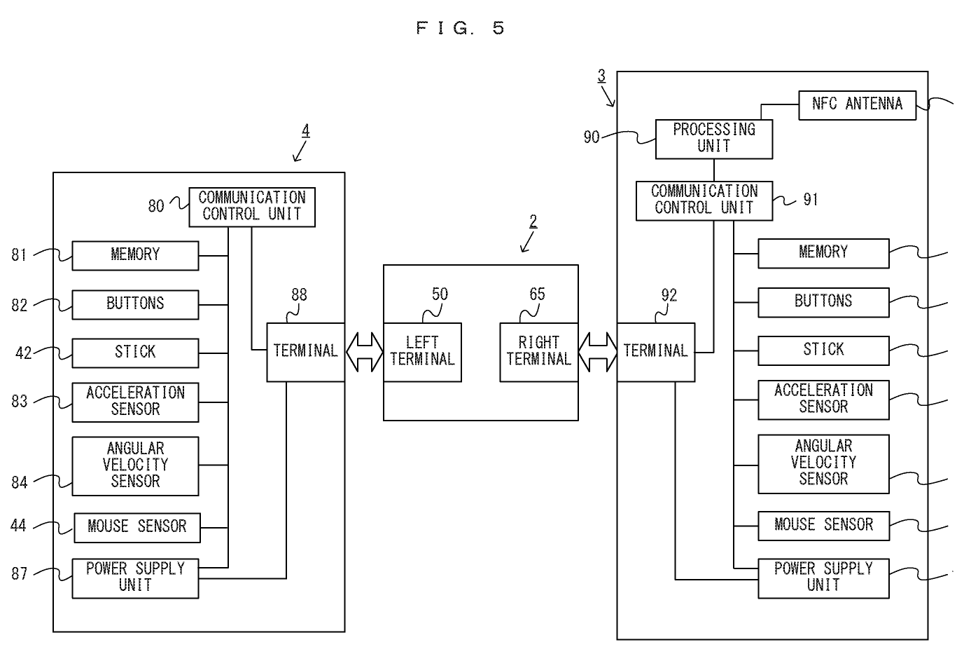

FIG. 5 is a block diagram showing an example of the configurations of the main body apparatus 2, the left controller 4, and the right controller 3. The details of the configuration of the main body apparatus 2 have already been shown in FIG. 4 and therefore are not shown in FIG. 5.

The left controller 4 includes a communication control unit 80 which performs communication with the main body apparatus 2. As shown in FIG. 5, the communication control unit 80 is connected to various components including a terminal 88. In a state where the left controller 4 is attached to the main body apparatus 2, the communication control unit 80 performs wired communication with the main body apparatus 2 via the terminal 88, and in a state where the left controller 4 is detached from the main body apparatus 2, the communication control unit 80 performs wireless communication (e.g., communication compliant with the standard of Bluetooth (registered trademark)) with the main body apparatus 2.

The left controller 4 includes a memory 81 such as a flash memory, for example. The communication control unit 80 is formed by a processor such as a microcomputer (or a microprocessor), for example, and executes various kinds of processing by executing firmware stored in the memory 81.

The communication control unit 80 acquires information about operations performed on each button 82 and the stick 42.

The left controller 4 includes an inertial sensor. Specifically, the left controller 4 includes an acceleration sensor 83 and an angular velocity sensor 84. The acceleration sensor 83 and the angular velocity sensor 84 are connected to the communication control unit 80. The communication control unit 80 repeatedly acquires detection results from the acceleration sensor 83 and the angular velocity sensor 84 at appropriate timings. The inertial sensor may be one of the acceleration sensor and the angular velocity sensor or may be another sensor.

The left controller 4 includes the mouse sensor 44. The mouse sensor 44 acquires data for calculating movement or the like of the left controller 4 placed on a placement surface. The communication control unit 80 repeatedly acquires the data acquired by the mouse sensor 44, at appropriate timings.

The communication control unit 80 transmits left controller data including acquired information or information obtained by performing predetermined processing on the acquired information, to the main body apparatus 2. The left controller data may be repeatedly transmitted at predetermined timings. For example, the communication control unit 80 may transmit the left controller data in response to a data request repeatedly received from the main body apparatus 2 at predetermined timings.

The left controller 4 includes a power supply unit 87. The power supply unit 87 includes a battery and a power control circuit. The power control circuit is connected to the battery and supplies power to each unit of the left controller 4 (specifically, each of units to be supplied with power from the battery).

As shown in FIG. 5, the right controller 3 has a configuration similar to the left controller 4. For example, the right controller 3 includes a communication control unit 91 which is composed of a processor or the like and performs communication with the main body apparatus 2. The right controller 3 includes a memory 94 connected to the communication control unit 91. The communication control unit 91 is connected to components including a terminal 92. The communication control unit 91 and the memory 94 have the same functions as the communication control unit 80 and the memory 81 of the left controller 4. Therefore, the communication control unit 91 is capable of performing communication with the main body apparatus 2 by both of wired communication via the terminal 92 and wireless communication not via the terminal 92, and controls communication that the right controller 3 performs with the main body apparatus 2. For example, the communication control unit 91 acquires information about operations performed on each button 95 and the stick 22 and transmits the information to the main body apparatus 2.

The right controller 3 includes a processing unit 90 and an NFC antenna 93. The processing unit 90 controls the NFC antenna 93 in accordance with an instruction from the main body apparatus 2 via the communication control unit 91. The NFC antenna 93 performs short-range wireless communication based on the standard of NFC (Near Field Communication).

### Operation manner for controllers

Next, the operation manner for the controllers will be described. In the exemplary embodiment, an operation manner in which one user uses the right controller 3 and the left controller 4 is assumed.

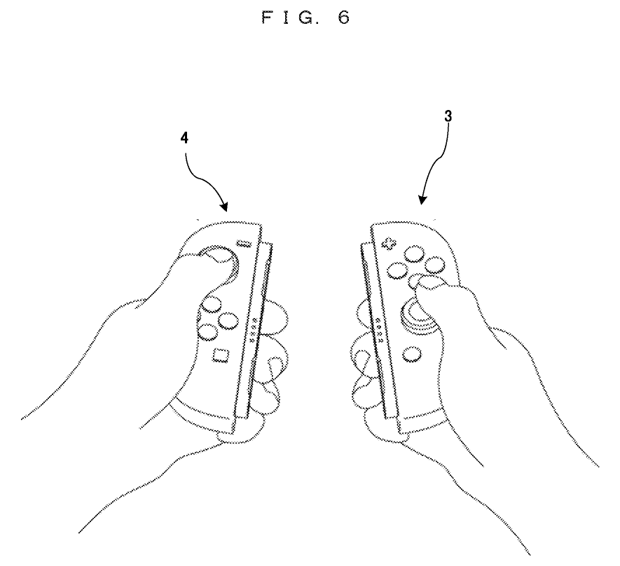

FIG. 6 is a schematic diagram showing an example of a state where the user operates the right controller 3 and the left controller 4 while grasping the right controller 3 by the right hand in a longitudinal holding manner and grasping the left controller 4 by the right hand in a longitudinal holding manner. As shown in FIG. 6, in a state where the right controller 3 is detached from the main body apparatus 2, the right controller 3 can be used while being grasped such that the longitudinal direction of the right controller 3 coincides with the up-down direction or the front-rear direction for the user. The left controller 4 can also be used in the same manner. In the following description, the operation manner shown in FIG. 6 is sometimes referred to as both-hand longitudinal holding manner.

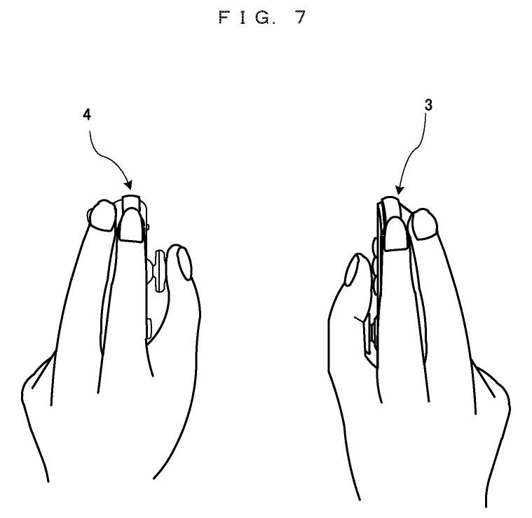

FIG. 7 shows an example of a state where the user puts the right hand on the right controller 3, puts the left hand on the left controller 4, places each controller on a placement surface, and uses each controller as a mouse. As shown in FIG. 7, the front portion of the right controller 3 faces frontward and the left portion thereof faces leftward. The palm of the right hand of the user covers the upper portion side of the right controller 3. The thumb of the right hand of the user is placed on the left portion side of the right controller 3. The thumb of the right hand of the user is put on the A button 12, for example. The index finger of the right hand of the user is put on the R button 20, for example, and the middle finger of the right hand of the user is put on the ZR button 21, for example. The user can operate the R button 20 and the ZR button 21 by the index finger or the middle finger of the right hand. The user can operate each input portion provided at the left portion, by the thumb of the right hand. In addition, when viewed from the user, the front portion of the left controller 4 faces frontward and the right portion thereof faces rightward. The palm of the left hand of the user covers the upper portion side of the left controller 4. The thumb of the left hand of the user is placed on the left portion side of the left controller 4. The thumb of the left hand of the user is put on the left stick 42, for example. Alternatively, the thumb of the left hand may be put on the left direction button 35. The index finger of the left hand of the user is put on an L button 40, for example, and the middle finger of the left hand of the user is put on a ZL button 41, for example. The user can operate the L button 40 and the ZL button 41 by the index finger or the middle finger of the left hand. The user can operate each input portion provided at the right portion, by the thumb of the left hand. In the following description, the operation manner shown in FIG. 7 is sometimes referred to as both-hand mouse manner.

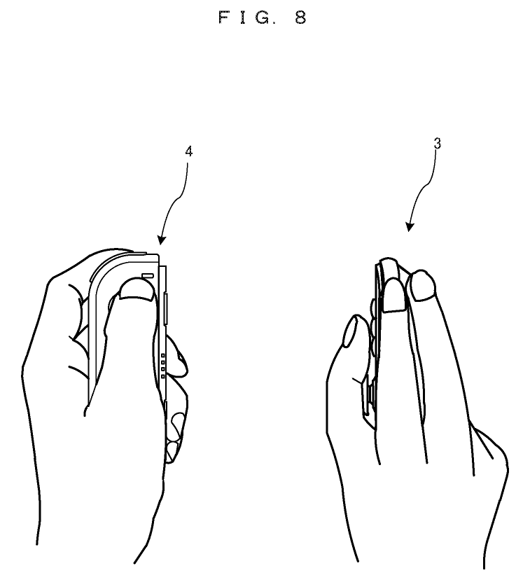

FIG. 8 is a schematic diagram showing an example of a state where the user operates the right controller 3 as a mouse and operates the left controller 4 while grasping the left controller 4 by the left hand in a longitudinal holding manner. In the following description, the operation manner shown in FIG. 8 is sometimes referred to as mixed operation manner.

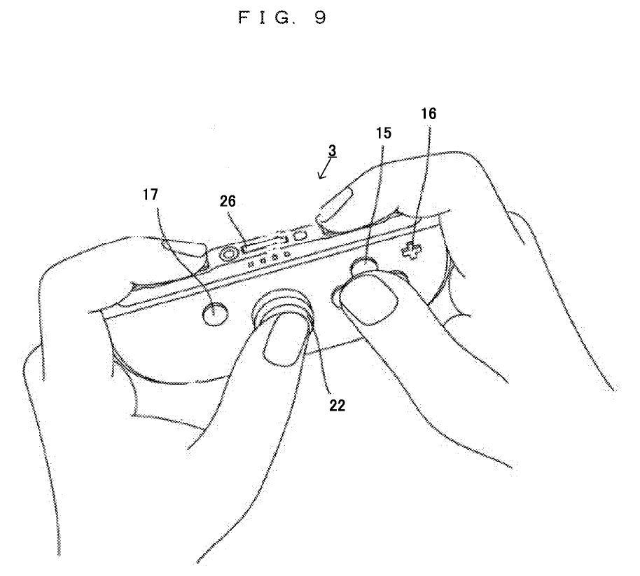

In addition to the above operation manners, as shown in FIG. 9, it is also possible for the user to operate the right controller 3 while grasping the right controller 3 by both hands in a horizontal holding manner. As shown in FIG. 9, in a state where the right controller 3 is detached from the main body apparatus 2, the right controller 3 is used such that the longitudinal direction of the right controller 3 coincides with the left-right direction of the operating user. The right controller 3 is grasped by one hand of the user on one side in the longitudinal direction (one side in the front-rear direction) and grasped by the other hand of the user on the other side. For example, the index fingers of both hands of the user are put on the bottom portion side of the right controller 3. Also, when the user uses the left controller 4 by both hands in a state where the left controller 4 is detached from the main body apparatus 2, the user can use the left controller 4 in the same manner.

Next, the information processing of the exemplary embodiment will be described.

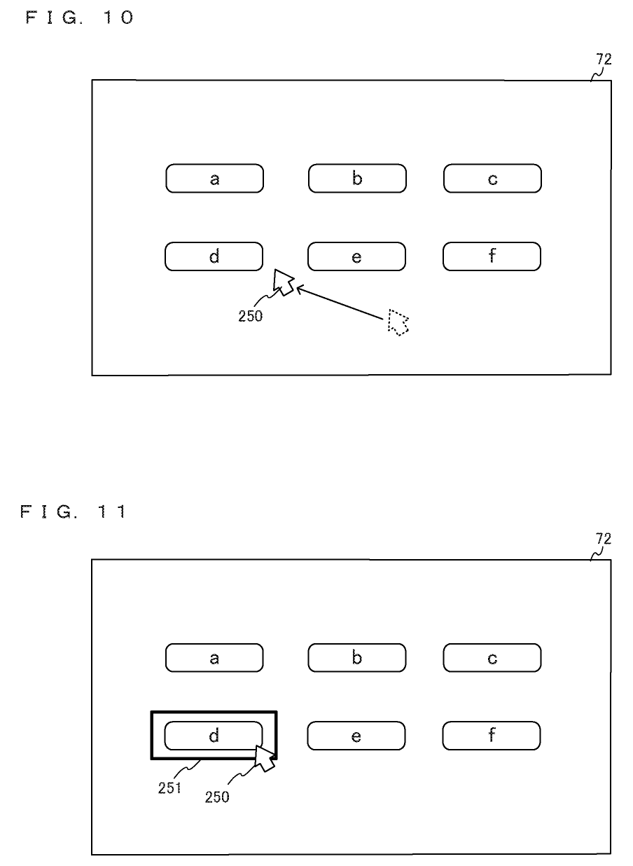

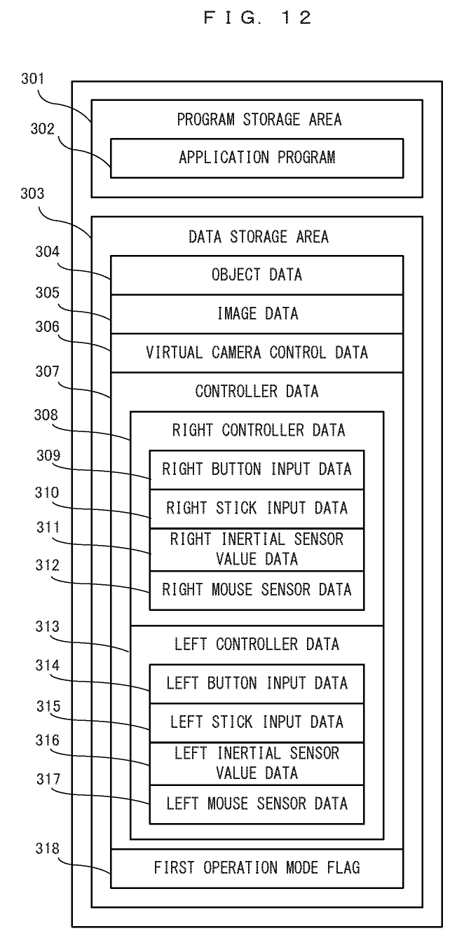

FIG. 10 and FIG. 11 show an example of a menu displayed on the display of the main body apparatus 2 or on an external display. The contents of the menu are not limited, and the menu may be, for example, a menu for selecting an application to be executed on the main body apparatus 2, a menu for changing the settings of the main body apparatus 2, or a menu for selecting a content. Alternatively, the menu may be a menu within an application currently being executed.

In the exemplary embodiment, there are two methods for operating the menu using the controller. However, there may be three or more operation methods. A method for switching between the operation methods will be described later. A first operation method is an operation method using mouse operation. As shown in FIG. 10, in the first operation method, a cursor 250 included in the menu is continuously moved by mouse operation. When a predetermined button of the controller, for example, the R button 20, is pressed in a state where the cursor 250 is superimposed on any of items (shown by a to f), processing corresponding to that item is executed. As an example, when the user operates in the above both-hand mouse manner (FIG. 7) or mixed operation manner (FIG. 8), the menu is operated by the first operation method. The cursor 250 may be moved by only one or either of operating the right controller 3 as a mouse and operating the left controller 4 as a mouse.

A second operation method is an operation method that does not use mouse operation. As shown in FIG. 11, in the second operation method, a frame 251 which encloses an item is moved discontinuously in response to operations on the directional input portion. For example, when the frame 251 encloses the item d, the frame 251 moves to a position where the frame 251 encloses the item e, which is adjacent to the item d on the right side, in response to a rightward operation on the directional input portion. Then, when a predetermined button of the controller, for example, the A button 12, is pressed, processing corresponding to the item enclosed by the frame 251 is executed. As an example, when the user operates in the above both-hand longitudinal holding manner (FIG. 6), the menu is operated by the second operation method.

As described above, the menu operation method changes according to the manner in which the user holds the controller, and thus the operability of menu operations by the user is improved.

The processing executed in response to operations on the operation portion of the controller may be the same or different between the first operation method and the second operation method. For example, in the first operation method, when the R button 20 is pressed, processing corresponding to the selected item may be executed, whereas in the second operation method, even when the R button 20 is pressed, processing corresponding to the selected item may not be executed, or other processing may be executed. Furthermore, for example, in the second operation method, a process of moving the frame 251 and the cursor 250 in response to operations on the stick 42 may be executed, whereas in the first operation method, the cursor 250 may not be moved in response to operations on the sticks 42 and 22.

The method of changing the processing to be executed in response to operations on the operation portion of the controller, based on the operation method, is not limited. For example, in a menu within an application executed on the main body apparatus 2, processing corresponding to an operation on the operation portion may be changed in the application, based on the operation method, or the system software of the main body apparatus 2 or the like may pass operation information to the application after the interpretation of operations on the operation portion is changed based on the operation method.

Furthermore, as shown in FIG. 11, in the case of the second operation method, the cursor 250 may also be displayed. The cursor 250 is displayed at a position corresponding to the position and size of the frame 251 or the item enclosed by the frame 251. The cursor 250 is moved discontinuously together with the frame 251. In the case of the first operation method, if no mouse operation is performed, the cursor 250 is displayed in a stationary state. However, in the case of the second operation method, the cursor 250 may be constantly moving. Here, “moving” does not refer to moving to the position of another item but refers to small vibrations or circular motions relative to or around a predetermined position, for example. This allows the user to easily recognize, for example, that the current operation method is the second operation method.

In the case of the second operation method, the cursor 250 may not be displayed. Alternatively, even in the case of the second operation method, a cursor may be displayed as described above, but the color, size, or shape of the cursor may be different from that of the cursor displayed in the case of the first operation method. Still alternatively, in the second operation method, the frame 251 may not be displayed, but a cursor may be displayed. The display means for indicating an item in the second operation method is not limited, and, for example, the color of the item itself may change. In addition, the types, positions, or sizes of the displayed items may change between the case of the first operation method and the case of the second operation method.

In the following description, the operation mode using the first operation method may be referred to as “first operation mode”, and the operation mode using the second operation method may be referred to as “second operation mode”.

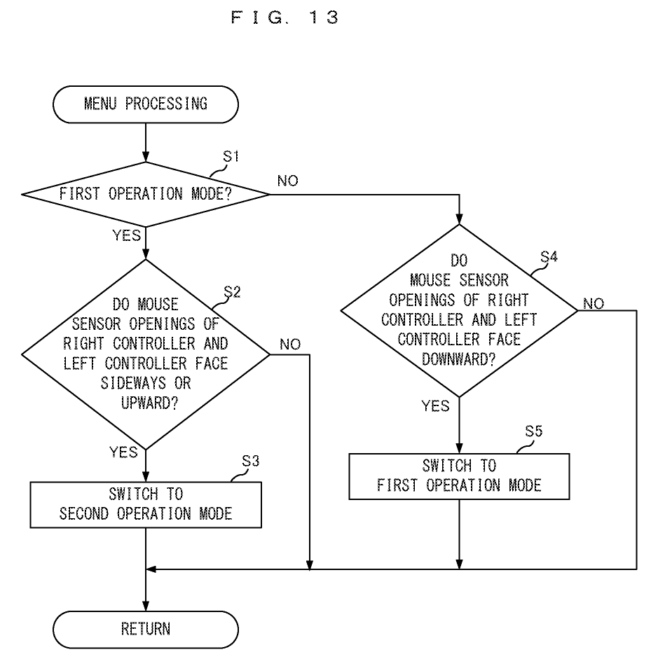

Next, various data stored in the memory will be described. FIG. 12 shows an example of data stored in the memory of the main body apparatus 2. In FIG. 12, a program storage area 301 and a data storage area 303 are shown separately for convenience. In reality, these areas do not need to be physically divided. In addition, more detailed storage areas or other storage areas may be conceptually provided.

The program storage area 301 includes an application program (hereinafter, AP program) 302. The AP program 302 may include game application programs, communication application programs, etc.

The data storage area 303 includes object data 304, image data 305, virtual camera control data 306, controller data 307, and a first operation mode flag 318.

The object data 304 is data for objects to be placed in a virtual space and is, for example, data for menus and objects such as cursors.

The image data 305 is image data for animation images, backgrounds, virtual effects, etc.

The virtual camera control data 306 is data for controlling a virtual camera placed in the virtual space to capture an image of the virtual space.

The controller data 307 is various data outputted from the controller and is used to determine the operation content. The controller data 307 includes right controller data 308 and left controller data 313. The right controller data 308 includes right button input data 309, right stick input data 310, right inertial sensor value data 311, and right mouse sensor data 312. The left controller data 313 includes left button input data 314, left stick input data 315, left inertial sensor value data 316, and left mouse sensor data 317.

The right button input data 309 is data indicating operations performed on each button 95 of the right controller 3. The right stick input data 310 is data indicating operations performed on the stick 22 of the right controller 3. The right stick input data 310 indicates the two-dimensional position of the stick 22. The content of the right stick input data 310 is not limited as long as the right stick input data 310 indicates the two-dimensional position, and, for example, the right stick input data 310 may indicate the amounts of change in the x-axis and y-axis from the initial position, or the right stick input data 310 may indicate the distance and angle from the initial position.

The right inertial sensor value data 311 is data outputted from the inertial sensor of the right controller 3 and is, for example, data that allows calculation of accelerations in the x, y, and z-axis directions (see FIG. 2) in the coordinate system of the right controller 3 and angular velocities around the x, y, and z axes. For example, the orientation, movement, etc., of the right controller 3 can be calculated using the right inertial sensor value data 311.

The right mouse sensor data 312 is data outputted from the mouse sensor 24 of the right controller 3. When the opening 23 of the mouse sensor 24 is closed by a placement surface or the like, the right mouse sensor data 312 is data indicating, for example, a movement distance per frame time in the y-axis direction and the z-axis direction in the coordinate system of the right controller 3 (i.e., the yz plane; see FIG. 2) relative to the placement surface or the like.

The left button input data 314 is data indicating operations performed on each button 82 of the left controller 4. The left stick input data 315 is data indicating operations performed on the stick 42 of the left controller 4.

The left inertial sensor value data 316 is data outputted from the inertial sensor of the left controller 4. Similar to the right controller 3, for example, the orientation, movement, etc., of the left controller 4 can be calculated using the left inertial sensor value data 316.

The left mouse sensor data 317 is data outputted from the mouse sensor 44 of the left controller 4. When an opening 43 of the mouse sensor 44 is closed by a placement surface or the like, the left mouse sensor data 317 is data indicating, for example, a movement distance per frame time in the y-axis direction and the z-axis direction in the coordinate system of the left controller 4 (i.e., the yz plane; see FIG. 3) relative to the placement surface or the like.

The timing at which the controller data 307 is acquired from the controller is not limited. For example, the above-described data may be acquired continuously. For example, when the currently executed application does not support mouse operations, the mouse sensor data may not be acquired. Conversely, for example, when the currently executed application supports mouse operations, the mouse sensor data may be acquired while button input data, stick input data, and inertial sensor value data may not be acquired.

The first operation mode flag 318 is data for determining the current operation mode. When the first operation mode flag 318 is ON, the first operation mode flag 318 indicates that the current operation mode is the first operation mode, and when the first operation mode flag 318 is OFF, the first operation mode flag 318 indicates that the current operation mode is the second operation mode.

The above various data are merely examples. Other data may be included, or some of the data may be omitted. The various data do not need to exist at all times, and, for example, may be added, deleted, or modified.

FIG. 13 is an example of a sequence diagram showing menu processing according to the exemplary embodiment. Here, only the processing related to switching the operation mode will be described, and the details of other processing are omitted. The order of each process is merely an example, and, for example, the processes may be executed simultaneously or in reverse order. Furthermore, the processes are described as being separated for convenience, but may be implemented as an integrated process. The following processes may also be executed at a predetermined interval (for example, per processing frame or every 1/30 seconds).

The outline of the processing shown in FIG. 13 is as follows: it is determined whether or not the direction of each mouse sensor opening, that is, the x-axis negative direction, is within a predetermined downward range (first range) that includes the gravity direction (true downward direction). Control is performed such that if the orientation of the mouse sensor opening of one controller is within the first range, the first operation method described above is used, and if the orientations of both mouse sensor openings are outside the first range, the second operation method described above is used.

A specific processing example will be described. First, the processor 63 determines whether or not the current operation mode is the first operation mode, based on the first operation mode flag 318 (S1). If the current operation mode is the first operation mode (YES in S1), next, the processor 63 determines whether or not the mouse sensor opening 23 of the right controller 3 and the mouse sensor opening 43 of the left controller 4 face sideways or upward (i.e., in a direction perpendicular to the gravity direction or in a direction opposite to the gravity direction). For example, the orientation of each controller is calculated based on the output of the above inertial sensor, and if the x-axis negative direction for each controller is outside the first range, these openings are determined to face sideways or upward.

If, as a result of the above determination, both the mouse sensor opening 23 of the right controller 3 and the mouse sensor opening 43 of the left controller 4 face sideways or upward (YES in S2), the processor 63 sets the first operation mode flag 318 to OFF (S3). Accordingly, the operation mode is switched from the first operation mode to the second operation mode.

On the other hand, if at least one of the mouse sensor opening 23 of the right controller 3 and the mouse sensor opening 43 of the left controller 4 neither faces sideways nor upward (NO in S2), the process in S3 above is skipped.

On the other hand, if, as a result of the determination in S1 above, the current operation mode is the second operation mode (NO in S1), next, the processor 63 determines whether or not the mouse sensor opening 23 of the right controller 3 or the mouse sensor opening 43 of the left controller 4 faces downward (S4). For example, the orientation of each controller is calculated, and it is determined whether or not the x-axis negative direction is within the first range. If, as a result of the determination, the mouse sensor opening of either controller faces downward (YES in S4), the processor 63 sets the first operation mode flag 318 to ON (S5). Accordingly, the operation mode is switched from the second operation mode to the first operation mode.

On the other hand, if both the mouse sensor opening 23 of the right controller 3 and the mouse sensor opening 43 of the left controller 4 do not face downward (NO in S4), the process in S5 above is skipped.

This is the end of the description of the sequence diagram showing the menu processing according to the exemplary embodiment.

As described above, in the exemplary embodiment, the operation mode is switched based on whether or not each mouse sensor opening faces downward. If at least one of the mouse sensor openings of the controllers faces downward, there is a possibility that mouse operations are intended, and thus setting the first operation mode is more likely to match the intention of the user. On the other hand, the controller may be lifted in order to adjust the mouse position at the time of mouse operation, and at this time, unintentionally, the mouse sensor opening may be oriented so as not to face downward. Considering this, when the mouse sensor openings of both controllers do not face downward, the operation mode is set to the second operation mode. In such a case, it can be inferred that the user is actively intending to operate the controllers in the above both-hand longitudinal holding manner, and thus setting the second operation mode is more likely to match the intention of the user.

In the above-described processing, the “range (threshold)” used for the determination for switching from the second operation mode to the first operation mode and the “range” used for the determination for switching from the first operation mode to the second operation mode may be different. For example, whether or not to switch from the first operation mode to the second operation mode may be determined based on whether or not the x-axis negative direction is within a second range that includes the direction perpendicular to the gravity direction but does not include the gravity direction and the direction opposite to the gravity direction. In this case, it can be said that it is determined whether or not the mouse sensor openings of the right controller and the left controller face sideways. The second range and the first range in the above processing may partially overlap. Alternatively, these ranges may not overlap, and there may be directions that do not belong to either range.

Furthermore, the above-described processing in FIG. 13 is merely an example and can be modified as appropriate. For example, regardless of the current operation mode, whether or not “the mouse sensor openings of the right controller 3 and the left controller 4 face sideways” and whether or not “the mouse sensor opening of the right controller 3 or the left controller 4 faces downward” may be determined. If the result of either determination is YES, the operation mode corresponding to that determination result may be set, and if the results of both determinations are NO, the current operation mode may be maintained.

For example, when the orientation of the mouse sensor opening of one controller is outside the first range, whether or not the orientation of the mouse sensor opening of the other controller is outside a third range may be determined in order to switch to the second operation mode. That is, for example, when determining whether or not both controllers face sideways or upward, a threshold for determining whether or not one controller faces sideways or upward and a threshold for determining whether or not the other controller faces sideways or upward may be made different.

Furthermore, the condition for switching from the second operation mode to the first operation mode may be a condition that the mouse sensor opening faces downward and is closed. For example, if the determination is based only on “facing downward”, there is a possibility that the mouse sensor opening will temporarily face downward while operations are performed in the both-hand longitudinal holding manner as shown in FIG. 6 above. On the other hand, if the determination is based only on “closed”, there is a possibility that the mouse sensor opening will be unintentionally closed by a finger while operations are performed in a longitudinal holding manner. Therefore, by setting the condition of both “facing downward” and “closed”, it becomes easier to infer that operations as a mouse are intended.

The method for the above determination as to “closure” is not limited. For example, a switch may be provided at the mouse sensor opening, or a distance sensor may be provided at the mouse sensor opening. In addition, closure may be determined based on whether data indicating mouse movement is outputted from the mouse sensor. Alternatively, the determination may be made as follows: for example, “image clarity data,” which is data indicating the clarity of a mouse sensor image, may be included in the controller data 307. The image clarity data is data calculated by the mouse sensor 24. The image clarity data is calculated based on the degree of brightness of the mouse sensor image and/or the degree regarding the number of feature points in the mouse sensor image, for example. The degree of brightness of the mouse sensor image or the degree regarding the number of feature points in the mouse sensor image may be directly used as the image clarity data. In addition, the image clarity data may be calculated based on another element. If the clarity indicated by the image clarity data is equal to or greater than a predetermined value, it can be inferred that the mouse sensor opening 23 is closed by a placement surface or the like. By using such image clarity data, it may be determined whether or not the mouse sensor opening is closed.

The condition for switching from the second operation mode to the first operation mode may be a condition of “being closed”. On the other hand, as the determination for switching from the first operation mode to the second operation mode, it may be determined whether or not both controllers face sideways, and the condition for switching from the first operation mode to the second operation mode does not have to include the additional condition of “not being closed”. However, “not being closed” may also be included in the condition. For the determination for switching from the second operation mode to the first operation mode, “being closed” may not be set as the condition, and for the determination for switching from the first operation mode to the second operation mode, “not being closed” may be set as the condition.

In the above second operation method, mouse operations may be completely disabled, or, for example, predetermined processing other than the above cursor movement may be executable based on mouse operations.

In the second operation method, the cursor 250 or the frame 251 may be continuously moved in response to operations on the stick 42. For example, in the case where there is no frame 251 and the cursor 250 is moved, the corresponding processing may be executed when a predetermined button is pressed while the cursor 250 is superimposed on an item, as in the case of the first operation method.

The above menu may also be a menu within a game application that uses mouse operations. The game is not limited, but for example, the menu may be a menu that is opened when a predetermined operation is performed in a game where a right leg is moved by operating the right controller 3 as a mouse and a left leg is moved by operating the left controller 4 as a mouse. Alternatively, the menu may be a menu that is opened when a predetermined operation is performed in a game where a right wheel is moved by operating the right controller 3 as a mouse and a left wheel is moved by operating the left controller 4 as a mouse. Since the menu is a menu within a game where the left and right controllers are operated as mice, there is a possibility that the user is intending to operate the controllers as mice. Therefore, setting the first operation mode based on the mouse sensor opening of the right or left controller facing downward is highly likely to match the intention of the user.

The application examples of the above first operation method and second operation method are not limited to menus, and the first operation method and the second operation method may be applied to, for example, games. For example, in the first operation method, the right leg of a player character may be moved by operating the right controller 3 as a mouse, and the left leg of the player character may be moved by operating the left controller 4 as a mouse, thereby moving the player character, and in the second operation method, the left and right legs may be moved by operating the left and right sticks, thereby moving the player character. Alternatively, in the second operation method, instead of individually controlling the left and right legs, the player character may be moved in an input direction by operating a single stick. Still alternatively, when the second operation method becomes active, instead of controlling the player character, the user may be allowed to operate items or terrain, or open a map and perform a map operation. Still alternatively, when the second operation method becomes active, a menu may be opened, and when the first operation method becomes active, the game may be returned to.

In addition to the conditions described above, the condition used for the determination for switching the operation mode may further include other conditions. For example, whether the orientation of each controller is stable, whether a predetermined button has been pressed, or whether the mouse is being moved (whether the mouse sensor output indicates mouse movement) may be used as the condition for switching.

Furthermore, the various determinations described above may be performed within each controller, by the operating system of the main body apparatus 2, or by an application executed by the main body apparatus 2.

The game system is an example of an information processing system, and the information processing system may be a system in which games are not executed.

For example, when a “processor of an information processing system” is recited, the processor may mean one or more processors in one apparatus such as a main body apparatus or may mean some or all of one or more processors included in each of multiple apparatuses such as a main body apparatus and a controller or a main body apparatus, a controller, and a server. The same applies to the case where a “memory of an information processing system” is recited and the case where another component is recited.

The program that causes a computer to execute each process may be a single program or may be a program group including a plurality of programs. The “certain program” does not necessarily mean a single program and may include a program group. In addition, the entirety of the program does not need to be stored in one apparatus. The “certain program” may mean, for example, the totality of programs that are stored in a plurality of apparatuses included in the information processing system, respectively.

In an information processing system including a terminal-side apparatus and a server-side apparatus capable of communicating via a network, at least part of the series of processes may be executed by the server-side apparatus. The server may be composed of a plurality of information processing apparatuses, and the processes may be executed by the plurality of information processing apparatuses in a shared manner.

Other exemplary embodiments will also be described. For example, as for the condition for switching from the first operation mode to the second operation mode, this switching may be made if only the mouse sensor opening of one controller faces sideways, and the condition for switching from the second operation mode to the first operation mode may be a condition that the mouse sensor openings of both controllers face downward.

In the above processing example, the example in which the orientation of each controller (output of each inertial sensor) is used for the determination for switching the operation mode has been given. In another exemplary embodiment, the orientation of each controller may be used for determination for switching from one operation mode to the other operation mode, but may not be used for determination for switching from the other operation mode to the one operation mode. For the determination for switching from the other operation mode to the one operation mode, for example, the closure status of each mouse sensor opening or input to a button/stick may be used instead.

Furthermore, the operation mode may be switched based on the closure status of each mouse sensor opening, without using the orientation of each controller. For example, the condition for switching from the first operation mode to the second operation mode may be a condition that the mouse sensor openings of both controllers are not closed. The condition for switching from the second operation mode to the first operation mode may be a condition that only one of the mouse sensor openings is closed. Alternatively, the condition for switching from the second operation mode to the first operation mode may be a condition that the mouse sensor openings of both controllers are closed. In this case, if only one mouse sensor opening is closed, the current operation mode may be maintained.

The operation mode may also be switched at least from one operation mode to the other operation mode, based on whether or not a mouse movement operation is being performed, without using the orientation of each controller. Alternatively, the operation mode may be switched at least from one operation mode to the other operation mode, based on whether or not a stick input is being performed.

Only one of the controllers may be configured to have a mouse function, and the other controller may be configured not to have a mouse function. In this case, the operation mode may be switched according to at least one of the orientation of and the closure status of the mouse sensor opening of the controller having a mouse function. Furthermore, the operation mode may also affect the operation or interpretation of the controller that does not have a mouse function.

Each controller may also include a physical switch for switching whether or not to use the controller as a mouse. If at least one of the physical switches is ON, the first operation mode may be set, and if both physical switches are OFF, the second operation mode may be set.

While the exemplary embodiment, the modifications, and the other exemplary embodiments have been described, the description thereof is in all aspects illustrative and not restrictive. It is to be understood that various other modifications and variations may be made to the exemplary embodiment, the modifications, and the other exemplary embodiments.

While the present disclosure has been described herein, it is to be understood that the above description is, in all aspects, merely an illustrative example, and is not intended to limit the scope thereof.

What is claimed is:

1. One or more non-transitory computer-readable storage media having stored therein instructions that, when executed, cause one or more processors to perform operations comprising:
acquiring first input device data including first inertial data corresponding to an output of an inertial sensor of a first input device and first mouse data corresponding to an output of a mouse sensor of the first input device;
acquiring second input device data including second inertial data corresponding to an output of an inertial sensor of a second input device and second mouse data corresponding to an output of a mouse sensor of the second input device;
performing processing corresponding to a set operation mode, based on the first input device data and the second input device data;
setting a first operation mode, based on an orientation of the first input device satisfying a first condition;
setting the first operation mode, based on an orientation of the second input device satisfying a second condition; and
setting a second operation mode, based on the orientation of the first input device satisfying a third condition and the orientation of the second input device satisfying a fourth condition, wherein
processing corresponding to the first operation mode includes processing in which an object is operated based on at least one of the first mouse data or the second mouse data.

2. The one or more non-transitory computer-readable storage media according to claim 1, wherein
the first condition is a condition satisfied when a mouse sensor opening of the first input device faces at least in a gravity direction, and
the second condition is a condition satisfied when a mouse sensor opening of the second input device faces at least in the gravity direction.

3. The one or more non-transitory computer-readable storage media according to claim 2, wherein
the third condition is a condition satisfied when the mouse sensor opening of the first input device faces at least in a direction perpendicular to the gravity direction, and
the fourth condition is a condition satisfied when the mouse sensor opening of the second input device faces at least in the direction perpendicular to the gravity direction.

4. The one or more non-transitory computer-readable storage media according to claim 3, wherein the operations further comprise:
setting the first operation mode, based on the orientation of the first input device satisfying the first condition and satisfying a condition satisfied when the mouse sensor opening of the first input device is closed; and
setting the first operation mode, based on the orientation of the second input device satisfying the second condition and satisfying a condition satisfied when the mouse sensor opening of the second input device is closed.

5. The one or more non-transitory computer-readable storage media according to claim 4, wherein the operations further comprise,
regardless of whether or not the condition satisfied when the mouse sensor opening of the first input device is closed and the condition satisfied when the mouse sensor opening of the second input device is closed are satisfied,
setting the second operation mode, based on the orientation of the first input device satisfying the third condition and the orientation of the second input device satisfying the fourth condition.

6. The one or more non-transitory computer-readable storage media according to claim 1, wherein processing corresponding to the second operation mode is processing in which the object is not operated based on the first mouse data and the second mouse data.

7. The one or more non-transitory computer-readable storage media according to claim 4, wherein processing corresponding to the second operation mode is processing in which no object is operated based on the first mouse data and the second mouse data.

8. The one or more non-transitory computer-readable storage media according to claim 1, wherein
the object is a cursor,
the first input device data includes first operation portion data corresponding to a user operation on an operation portion of the first input device, and
processing corresponding to the second operation mode includes processing in which the cursor is moved based on the first operation portion data.

9. The one or more non-transitory computer-readable storage media according to claim 8, wherein
the processing corresponding to the first operation mode includes processing in which the cursor is continuously moved based on at least one of the first mouse data or the second mouse data, and
the processing corresponding to the second operation mode includes processing in which the cursor is discontinuously moved based on the first operation portion data.

10. The one or more non-transitory computer-readable storage media according to claim 9, wherein the cursor displayed when the first operation mode is set and the cursor displayed when the second operation mode is set are the same.

11. The one or more non-transitory computer-readable storage media according to claim 10, wherein
while the first input device and the second input device are not being operated,
the cursor displayed when the first operation mode is set is stopped, and the cursor displayed when the second operation mode is set is moved.

12. The one or more non-transitory computer-readable storage media according to claim 1, wherein the processing corresponding to the first operation mode includes processing in which the object is operated based on both the first mouse data and the second mouse data.

13. The one or more non-transitory computer-readable storage media according to claim 1, wherein
the operations further comprise performing game processing, and
the game processing includes a game portion in which both the first mouse data and the second mouse data are used, and a menu portion in which one of a plurality of operation modes including the first operation mode and the second operation mode is set.

14. A computer-implemented method comprising:
acquiring first input device data including first inertial data corresponding to an output of an inertial sensor of a first input device and first mouse data corresponding to an output of a mouse sensor of the first input device;
acquiring second input device data including second inertial data corresponding to an output of an inertial sensor of a second input device and second mouse data corresponding to an output of a mouse sensor of the second input device;
performing processing corresponding to a set operation mode, based on the first input device data and the second input device data;
setting a first operation mode, based on an orientation of the first input device satisfying a first condition;
setting the first operation mode, based on an orientation of the second input device satisfying a second condition; and
setting a second operation mode, based on the orientation of the first input device satisfying a third condition and the orientation of the second input device satisfying a fourth condition, wherein
processing corresponding to the first operation mode includes processing in which an object is operated based on at least one of the first mouse data or the second mouse data.

15. An information processing system comprising:
a first input device comprising a first inertial sensor and a first mouse sensor, and configured to output first input device data including first inertial data corresponding to an output of the first inertial sensor and first mouse data corresponding to an output of the first mouse sensor;
a second input device comprising a second inertial sensor and a second mouse sensor, and configured to output second input device data including second inertial data corresponding to output of the second inertial sensor and second mouse data corresponding to an output of the second mouse sensor;
an apparatus comprising one or more processors and one or more non-transitory computer-readable storage media having stored therein instructions that, when executed, cause the one or more processors to perform operations comprising:
acquiring the first input device data from the first input device;
acquiring the second input device data from the second input device;
performing processing corresponding to a set operation mode, based on the first input device data and the second input device data;
setting a first operation mode, based on an orientation of the first input device satisfying a first condition;
setting the first operation mode, based on an orientation of the second input device satisfying a second condition; and
setting a second operation mode, based on the orientation of the first input device satisfying a third condition and the orientation of the second input device satisfying a fourth condition, wherein
processing corresponding to the first operation mode includes processing in which an object is operated based on at least one of the first mouse data or the second mouse data.
